(19) United States
(12) Patent Application Publication
(10) Pub. No.: US 2021/0169024 A1
(43) Pub. Date: Jun. 10, 2021

(54) Smart Predictive Sprinkler

(71) Applicant: Amitava Ray, Boulder, CO (US)

(72) Inventor: Amitava Ray, Boulder, CO (US)

(21) Appl. No.: 16/947,836

(22) Filed: Aug. 19, 2020

(51) Int. Cl. A01G 25/16

(52) U.S. Cl. CPC A01G 25/167; A01G 25/165

(57) ABSTRACT

ASPSS is a smart sprinkler controller device that;
1. Measures many factors such as soil humidity of a sprinkler zone, surface temperature of that zone, atmospheric humidity.
2. Primary interface is through a mobile/web application.
   a. The said application enables users to fine tune parameters such as threshold humidity, threshold temperature etc. for operation.
3. Integrates directly with weather data providers.
4. Waits in case of prediction of precipitation before deciding to operate.
Has an internal algorithm, that determines operation of solenoid-valves that switch on or off to provide water to sprinkler-heads.
6. Decides if there is any requirement for additional moisture at a zone and whether operating the sprinkler-heads of that zone will not end up with most of it evaporating,

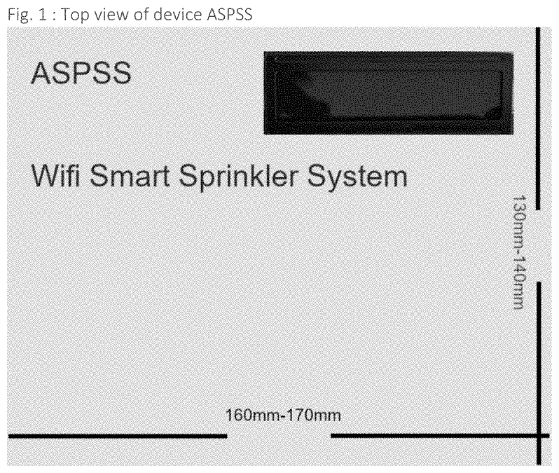

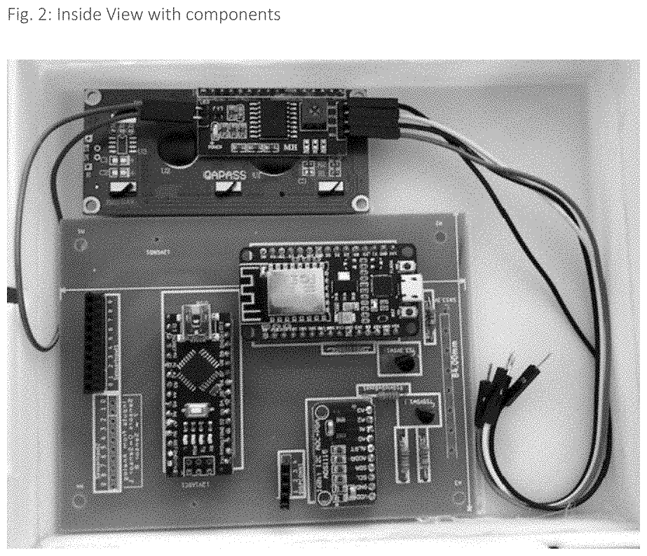

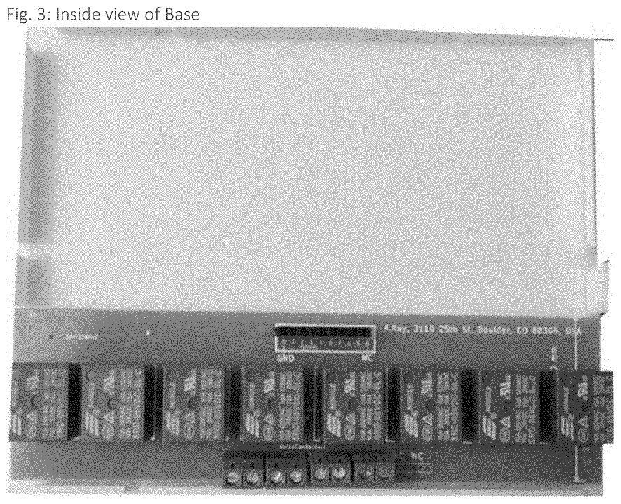

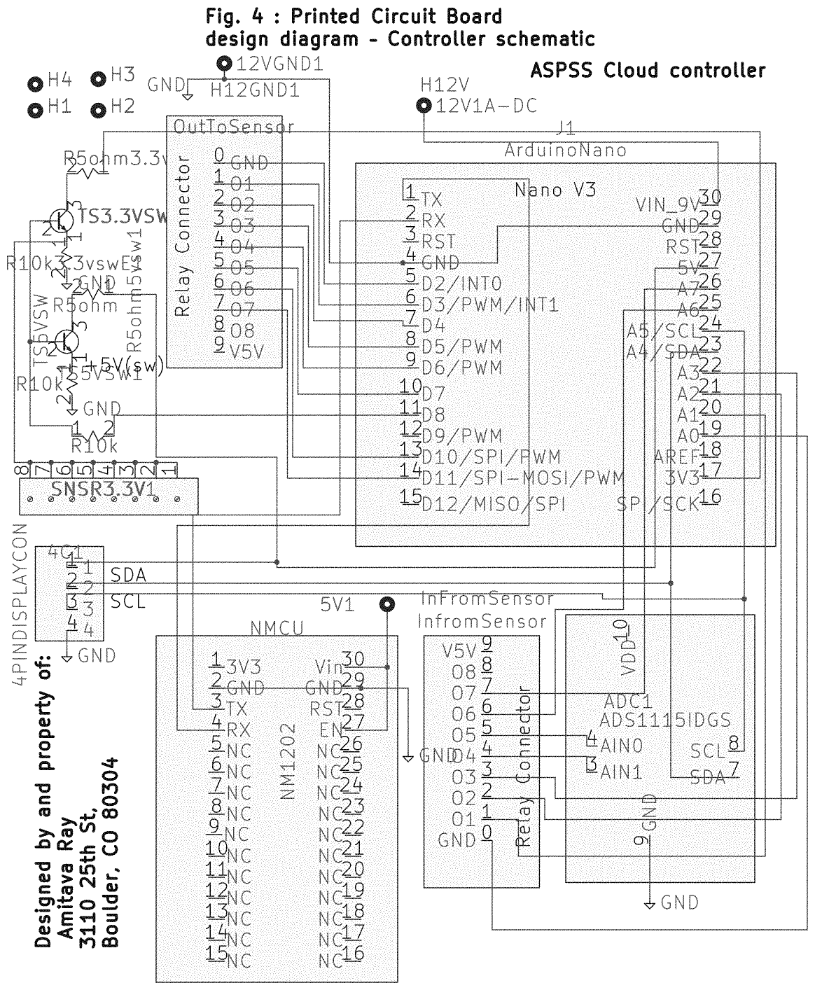

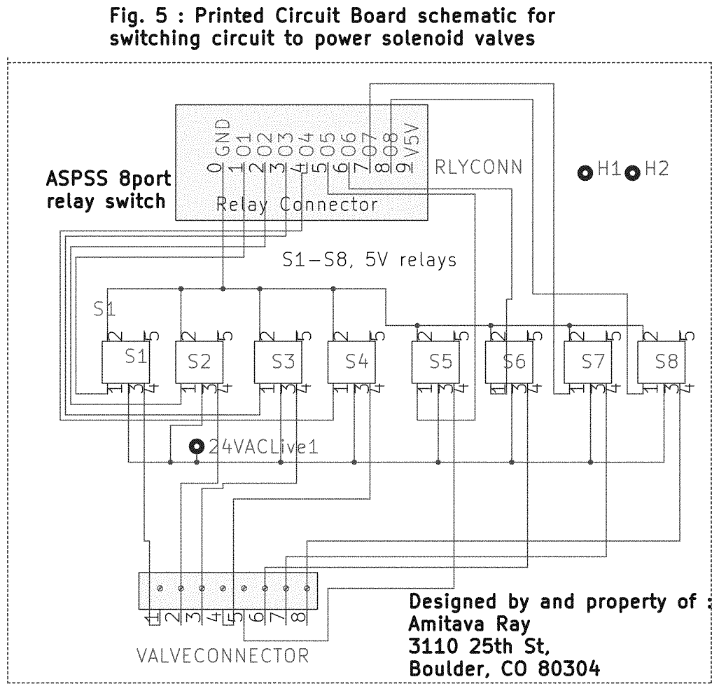

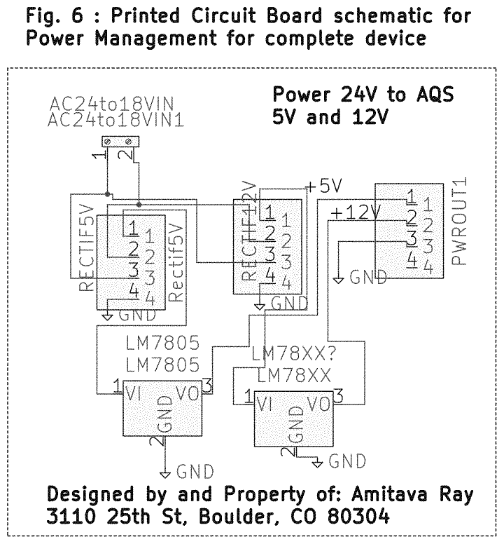

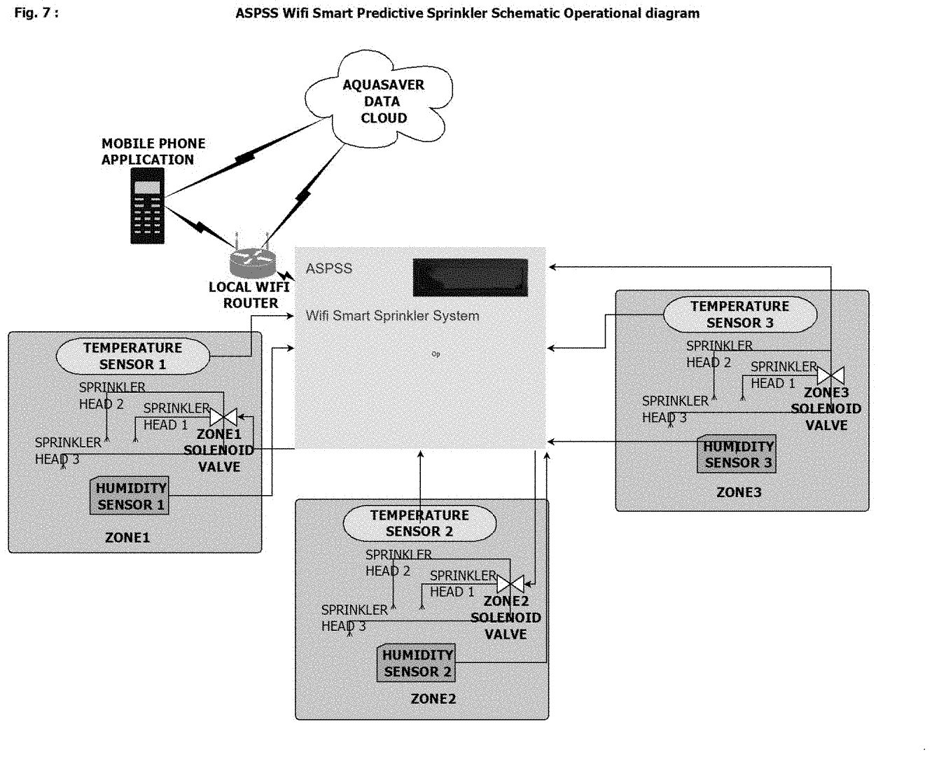

### BACKGROUND

With worldwide freshwater resources getting depleted at an alarming rate a disproportionate amount of water is wasted with timer-based sprinklers. Energy is wasted adding to global warming. The ASPSS device addresses this problem.

### SUMMARY

ASPSS is a smart electronic sprinkler valve controller. It works to make sure that a sprinkler system operates efficiently only when needed to keep the turf green while eliminating wastage of precious sweet water. ASPSS has built-in intelligence to capture soil-moisture data from strategically placed capacitive moisture sensors in the area to be watered. It connects to an internet cloud service to gather weather forecast data through any existing WiFi network. Based on the data collected ASPSS decides on when to switch on or switch off sprinkler solenoid valves. It has embedded artificial intelligence to wait in case of upcoming precipitation.

### EXPLANATION OF DRAWINGS PROVIDED IN DRAWINGS.PDF FILE

Diagram 1:

This is the top view of the ASPSS device in its enclosure; note that the enclosure in the diagram will have more information and may come in different colors.

Diagram 2:

This diagram shows one part of the interior with the core controller circuit board and a digital display circuit

Diagram 3:

This diagram shows the base of the ASPSS device enclosure with the switching circuit that connects to the controller circuit mentioned in Diagram 2 and provides power to the individual sprinkler solenoid valves when the controller in Diagram 1 directs it.

Diagram 4:

This is the main electronic circuit design schematic of the controller system as seen in Diagram 1.

Diagram 5:

This diagram shows the main electronic design schematic of the switching mechanism for sprinkler solenoid valves,

Diagram 6:

This diagram shows the main schematic of power distribution for the entire ASPSS device; it accepts a 24 Volt 750 milli ampere input and distributes that to various components of the ASPSS device.

Diagram 7:

This diagram shows the overall schematic of how the ASPSS system works while in operations

### DETAILED DESCRIPTION

ASPSS is a smart controller device that:
1. Can be programmed to operate at certain times of the day (similar to existing timer-based sprinkler controllers),
2. Measures many factors such as soil humidity of a sprinkler zone, surface temperature of that zone, atmospheric humidity,
3. Has an active built-in LCD display. However, the said device's primary interface is through a mobile/web application,
   a. The mobile/web application will be able to set parameters such as current date and time, operating times of the device.
   b. The user of the device will also be able to fine tune parameters such as threshold humidity, threshold temperature etc. for operation.
4. Integrates directly with weather data providers. Therefore, if there is a prediction of precipitation it waits to make sure that the precipitation indeed happens before deciding to operate.
5. Has an internal algorithm, that determines operation of solenoid-valves that switch on or off to provide water to sprinkler-heads.
6. Decides if there is any requirement for additional moisture at a zone and whether operating the sprinkler-heads of that zone will not end up with most of it evaporating.

1. A water sprinkler control system comprising:
electronic circuits that control the switching ON or OFF of multiple 24-volt (AC) sprinkler solenoid valves by measuring. soil moisture content and short-term weather forecast;
a display panel; and a plastic encasement for the said circuits and display panel.
